(19) United States
(12) Patent Application Publication
(10) Pub. No.: US 2007/0222277 A1
(43) Pub. Date: Sep. 27, 2007

(54) Wheel shield

(76) Inventor: Adam Israel, Beaverton, OR (US)

Correspondence Address: JAMES RAY & ASSOCIATES, 2640 PITCAIRN ROAD, MONROEVILLE, PA, 15146, US

(21) Appl. No.: 11/726,119

(22) Filed: Mar. 21, 2007

Related U.S. Application Data
(60) Provisional application No. 60/784,150, filed on Mar. 21, 2006.

(51) Int. Cl. B60B 7/00

(52) U.S. Cl. 301/37.104

(57) ABSTRACT

A tire rim shield to protect a tire rim while cleaning a rubber tire attached to such tire rim. The tire rim protector includes a predetermined shaped member. Such dome shaped member having a predetermined diameter and extends upwardly a predetermined distance. There is a handle member disposed on an outer surface of such dome shaped member substantially at a center thereof.

### CROSS REFERENCE TO RELATED APPLICATION

This patent application is related to and claims priority from U.S. Provisional Patent Application Ser. No. 60/784,150 filed Mar. 21, 2006. The teachings in the referenced Provisional Patent Application are incorporated herein by reference thereto.

### FIELD OF THE INVENTION

The present invention relates, in general, to vehicle wheels and, more particularly, this invention relates to a protective shield for the rim of a vehicle wheel when using a tire cleaner and or rubber protectant on a rubber tire.

### BACKGROUND OF THE INVENTION

Prior to the conception and development of the present invention, as is generally well known in the prior art, when tire dressings and cleaning solutions are applied to vehicle tires it is oftentimes the case that an over-spray will be deposited on the tire rims. This situation will most likely result in oxidation of the rims as well as causing corrosion. Furthermore, oxidation causes the rims to take on a dull finish.

Therefore, the rims may require cleaning with harsh chemicals which can result in damage to the surface finish of the rims thereby detracting from the overall appearance of the vehicle. This, in turn, can and does prematurely decrease the resale value of the vehicle.

### SUMMARY OF THE INVENTION

The present invention provides a tire rim shield that is designed to protect a tire rim while cleaning a rubber tire attached to such tire rim. The tire rim protector includes a predetermined shaped member having a predetermined diameter and which extends upwardly a predetermined distance. A handle member is disposed on an outer surface of such dome shaped member substantially at a center thereof.

### OBJECTS OF THE INVENTION

It is, therefore, one of the primary objects of the present invention to provide a vehicle wheel shield to protect the rim while applying cleaning solutions or rubber tire protectant which will substantially minimize damage to the rim from oxidation and corrosion.

Another object of the present invention is to provide a vehicle wheel shield to protect the rim while applying cleaning solutions or rubber tire protectant which is easy to use.

Still another object of the present invention is to provide a vehicle wheel shield to protect the rim while applying cleaning solutions or rubber tire protectant which is relatively inexpensive to manufacture.

Yet another object of the present invention is to provide a vehicle wheel shield to protect the rim while applying cleaning solutions or rubber tire protectant which is light weight.

An additional object of the present invention is to provide a vehicle wheel shield to protect the rim while applying cleaning solutions or rubber tire protectant which can be reused.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is side elevation view of a presently preferred embodiment tire rim shield constructed according to the invention; and

FIG. 2 is a top view of the tire rim shield illustrated in FIG. 1.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

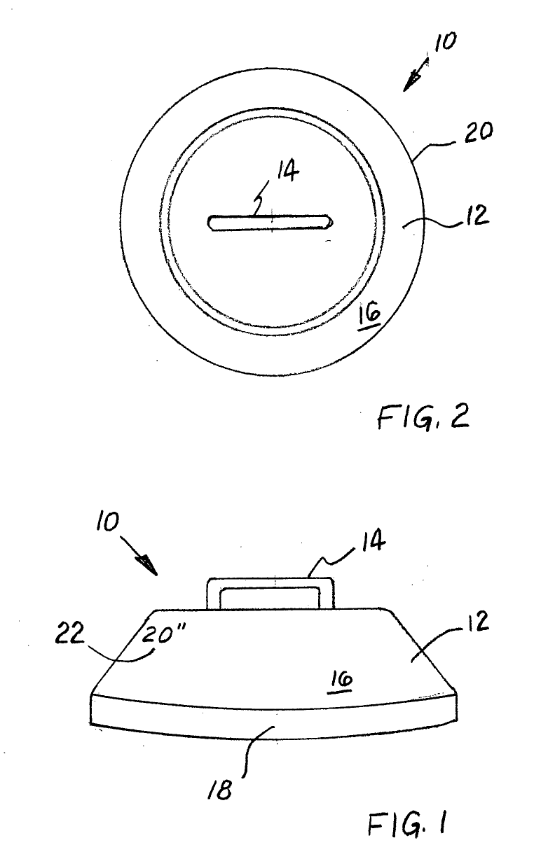

Reference is now made, more particularly, to FIGS. 1 and 2. Illustrated therein is a presently preferred embodiment of a tire rim shield, generally designated 10. Such tire rim shield 10 protects tire rim (not shown) while cleaning a rubber tire (not shown) attached to such tire rim. Tire rim shield 10 includes a predetermined shaped member 12. Such predetermined shaped member is, preferably, a generally round dome shaped member having a predetermined diameter, preferably between about 16.0 to about 24.0 inches, and extends upwardly a predetermined distance from a bottom edge of such generally round dome shaped member 12. Dome shaped member 12 is formed from a predetermined material. Such first pre-selected material is selected from the group consisting of plastic and aluminum. Preferably, such predetermined material is plastic.

A handle member 14 is disposed on an outer surface 16 of such dome shaped member 12 substantially at a center thereof. The handle member 14 is formed from a second pre-selected material which is preferably identical to the first pre-selected material.

The first pre-selected material and the second pre-selected material are selected from the group consisting of aluminum and plastic. Preferably, such first pre-selected material and the second pre-selected material are plastic.

In the presently preferred embodiment of the invention, such tire rim shield 10 further includes a lip portion 18 extending downwardly from an outer perimeter 18 of such generally round dome shaped member 12.

Furthermore, in the presently preferred embodiment of the invention such tire rim shield 10 will further include a size indicator 22 formed on the outer surface 16 of the tire rim shield 10.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A tire rim shield to protect such tire rim while cleaning a rubber tire attached to such tire rim, said tire rim protector comprising:
(a) a predetermined shaped member, said dome shaped member having a predetermined diameter and extends upwardly a predetermined distance, said generally round dome shaped member is formed from a first pre-selected material; and
(b) a handle member disposed on an outer surface of said dome shaped member substantially at a center thereof, said handle member is formed from a second pre-selected material.

2. A tire rim shield, according to claim 1, wherein said predetermined shaped member is a generally round dome shaped member.

3. A tire rim shield, according to claim 2, wherein said first pre-selected material and said second pre-selected material are identical.

4. A tire rim shield, according to claim 3, wherein said first pre-selected material and said second pre-selected material are selected from the group consisting of aluminum and plastic.

5. A tire rim shield, according to claim 1, wherein said predetermined diameter is selected from between about 16.0 and about 24.0 inches.

6. A tire rim shield, according to claim 1, wherein said tire rim shield further includes a lip portion extending downwardly from an outer perimeter of said generally round dome shaped member.

7. A tire rim shield, according to claim 1, wherein said tire rim shield further includes a size indicator formed on the outer surface of said tire rim shield.
